(19) United States
(12) Patent Application Publication
(10) Pub. No.: US 2002/0029520 A1
(43) Pub. Date: Mar. 14, 2002

(54) Decorative attachments and methods of use

(76) Inventor: Donald E. Weder, Highland, IL (US)

Correspondence Address: Dunlap, Codding & Rogers, P.C., Suite 420, 9400 North Broadway, Oklahoma City, OK, 73114, US

(21) Appl. No.: 09/990,900

(22) Filed: Nov. 16, 2001

Related U.S. Application Data
(63) Continuation of application No. 09/635,519, filed on Aug. 9, 2000.
Application No. 09/635,519 is a continuation of application No. 09/460,528, filed on Dec. 13, 1999, now abandoned.
Application No. 09/460,528 is a continuation of application No. 09/083,286, filed on May 21, 1998, now abandoned.
(63) Continuation of application No. 09/459,960, filed on Dec. 13, 1999, now abandoned.

(51) Int. Cl. A01G 9/02

(52) U.S. Cl. 47/72

(57) ABSTRACT

A decorative pop-up attachment positionable and connectable to an item, such as a pot or a container, a wrapping for a floral grouping, a wrapping for a pot or a container, a preformed flower pot cover, or a floral grouping. Methods for using decorative pop-up attachments.

### CROSS REFERENCE TO RELATED APPLICATIONS

This application is a continuation-in-part of U.S. Ser. No. 08/485,840, filed Jun. 7, 1995 entitled WRAPPING MATERIAL HAVING AN EXTENSION FOR DESIGN INDICIA FOR WRAPPING FLOWER POTS AND FLORAL ARRANGEMENTS AND METHODS; which is a continuation-in-part of U.S. Ser. No. 07/973,471, filed Nov. 9, 1992 entitled WRAPPING MATERIAL HAVING AN EXTENSION FOR DESIGN INDICIA FOR WRAPPING FLOWER POTS AND FLORAL ARRANGEMENTS AND METHODS, now U.S. Pat. No. 5,544,469.

### BACKGROUND OF THE INVENTION

1. Field of the Invention

This invention relates to decorative pop-up attachments connected to pots, floral wrappings for flowers and pots or containers, and preformed flower pot covers, and the methods of making and using same.

2. Description of Related Art

Including Information Disclosed Under 37 CFR § 1.97 and 37 CFR § 1.98

Sheets of material have been utilized to form decorative wrappings about flower pots and floral groupings, and have been utilized to form preformed decorative flower pot covers. One floral wrapping is disclosed in U.S. Pat. No. 5,111,638, entitled “Method For Wrapping An Object With A Material Having Pressure Sensitive Adhesive Thereon”, which illustrates wrapping pots with sheets of material. A floral wrapping using a sheet of material is shown in U.S. Pat. No. 5,181,364, entitled “Wrapping A Floral Grouping With Sheets Having Adhesive Or Cohesive Applied Thereto”. A floral wrapping using a flattened or unflattened sleeve is shown in U.S. Pat. No. 5,572,851, entitled “Plant package Having A Detahable Sleeves And Methods”. Preformed decorative flower pot covers are disclosed in U.S. Pat. No. 4,773,182, entitled “Article Forming System”, which discloses a decorative article, and article forming system.

Labels have sometimes been applied to pots, and to floral wrappings and preformed decorative flower pot covers. These labels include price labels, UPC bar code labels, and labels describing the plant contained within a container or wrapping, and/or its care (known in the art as “care tags”).

The prior art discloses sheets of material which decoratively cover flowers and containers, and labels for these items. The prior art does not disclose a decorative pop-up design attachment which may be connected to a wrapping for flowers, or a pot or container, or a preformed flower pot cover, or to flowers themselves. Therefore, there is a need felt within the art for a decorative pop-up attachment which utilizes not print or symbols (such as, but not by way of limitation, a UPC bar code), but which has a design, such as, but not by way of limitation, a whimsical character (a drawing of Peter Rabbit), used as a decoration on at least one end of a decorative pop-up attachment.

The decorative pop-up attachment is an attachment which is connected to the above-referenced items, and which is designed to extend a distance from the item. The decorative pop-up attachment will have a decoration which is whimsical, or related to a particular theme, such as, but not by way of limitation, a birthday, holiday, anniversary, and the like.

### BRIEF SUMMARY OF THE INVENTION

A method for using a decorative pop-up attachment with a floral grouping is disclosed. A decorative pop-up attachment is provided, comprising a sheet of material having an outer periphery and having a decorative end having design indicia thereon. The sheet of material is sized smaller than at least a portion of an outer diameter of a floral grouping. The floral grouping has a flower portion and a stem portion. The decorative pop-up attachment is disposed in the floral grouping, and positioned in the floral grouping whereby the decorative end of the decorative pop-up attachment extends a distance away from the flower portion of the floral grouping for displaying design indicia on the decorative end. The decorative pop-up extension is connected to the floral grouping.

Another method for using a decorative pop-up attachment is disclosed as well. A floral grouping having a flower portion and a stem portion, and having an outer diameter, is provided. A decorative pop-up attachment is provided, which comprises a sheet of material having an outer periphery and having a decorative end having-design indicia thereon. The sheet of material sized smaller than at least a portion of the outer diameter of the floral grouping. The decorative pop-up attachment is disposed in the floral grouping, and positioned in the floral grouping whereby the decorative end of the decorative pop-up attachment extends a distance away from the flower portion of the floral grouping for displaying design indicia on the decorative end. The decorative pop-up attachment is then connected to the floral grouping.

Still another method for using a decorative pop-up attachment with a floral grouping is disclosed. A decorative pop-up attachment is provided, which comprises a sheet of material having an outer periphery and having a decorative end having design indicia thereon. At least a portion of the outer periphery adjacent the decorative end follows the outline of the design indicia such that the decorative end is complementary in shape to the design indicia. The sheet of material is sized smaller than at least a portion of an outer diameter of a floral grouping. The floral grouping has a flower portion and a stem portion. The decorative pop-up attachment is disposed in the floral grouping, and the decorative pop-up attachment is positioned in the floral grouping whereby decorative end of the decorative pop-up attachment extends a distance away from the flower portion of the floral grouping for displaying design indicia on the decorative end. The decorative pop-up attachment is connected to the floral grouping.

Still yet another method for using a decorative pop-up attachment is disclosed as well. A floral grouping having a flower portion and a stem portion, and having an outer diameter is provided. A decorative pop-up attachment is provided, which comprises a sheet of material having an outer periphery and a decorative end having design indicia thereon. At least a portion of the outer periphery adjacent the decorative end follows the outline of the design indicia such that the decorative end is complementary in shape to the design indicia. The sheet of material sized smaller than at least a portion of the outer diameter of the floral grouping. The decorative pop-up attachment is disposed in the floral grouping. The decorative pop-up attachment is positioned in the floral grouping whereby the decorative end of the decorative pop-up attachment extends a distance away from the flower portion of the floral grouping for displaying design indicia on the decorative end. Then the decorative pop-up attachment is connected to the floral grouping.

The decorative pop-up attachment may comprise a bonding material. The bonding material may be an adhesive bonding material, or alternatively, a cohesive bonding material. The sheet of material is constructed from a material selected from the group consisting of paper, cellophane, foil, plastic film, metallized film, fabric, fiber, burlap and any combination thereof. The sheet of material has characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof. The sheet of material has a thickness in a range from about 0.5 mils to about 50, mils. The sheet of material may also have a thickness in a range from about 1.0 mils to about 30 mils The sheet of material may further have a thickness in a range from about 3 mils to about 25 mils. In addition, the sheet of material may have a thickness in a range from about 4 mils to about 15 mils. And, the sheet of material may also have a thickness in a range from about 4 mils to about 10 mils. The decorative pop-up attachment may be disposed adjacent at least a portion of the stem portion of the floral grouping. The decorative pop-up attachment may be connected to the floral grouping via a frictional engagement between the decorative pop-up attachment and the floral grouping. At least a portion of the outer periphery of the sheet of material adjacent the decorative end follows the outline of the design indicia such that the decorative end is complementary in shape to the design indicia. It will be appreciated that all of the characteristics listed herein may be included in some, or all, apparatus described and shown herein.

### BRIEF DESCRIPTION OF THE SEVERAL VIEWS OF THE DRAWINGS

FIG. 1 is a perspective view of the upper surface of a decorative pop-up attachment formed from a sheet of material constructed in accordance with the present invention, showing the design indicia on a decorative end, and showing one corner lifted for illustration purposes only.

FIG. 2 is a perspective view of the lower surface of a decorative pop-up attachment of FIG. 1.

FIG. 3 is a perspective view of a pad of sheets of material, each of which forms a decorative pop-up attachment, showing a portion of the top sheet of material lifted from the pad, exposing the next sheet of material.

FIG. 4 is a perspective view of a pot, and a decorative popup attachment spaced a distance therefrom.

FIG. 5 is a perspective view of the pot of FIG. 4, but showing the decorative pop-up attachment disposed adjacent the outer peripheral surface of the pot and positioned upon and connected to the pot.

FIG. 6 is a perspective view of a floral wrapping sheet of material, having one edge lifted for illustration purposes only.

FIG. 7 is a perspective view of the sheet of material of FIG. 6, having a floral grouping disposed thereon.

FIG. 8 is a perspective view of a the sheet of material formed into a wrapping for the floral grouping, showing one portion of the floral wrapping sheet of material overlapping at least one other portion of the floral wrapping sheet of material to form the wrapping, and a decorative pop-up attachment spaced a distance from the wrapping.

FIG. 9 is a perspective view of the wrapping for the floral grouping of FIG. 8, but showing the decorative pop-up attachment disposed adjacent to the outer peripheral surface of the wrapping, and positioned upon and connected to the wrapping.

FIG. 10 is a perspective view of an opened sleeve used to form a wrapping for a floral grouping.

FIG. 11 is a perspective view of the sleeve of FIG. 10 which has formed a wrapping for a floral grouping disposed into and contained within the sleeve, the stem portion of the floral grouping extending beyond the lower end of the wrapping, and a decorative pop-up attachment spaced a distance therefrom.

FIG. 12 is a perspective view of the wrapping of FIG. 11, showing the decorative pop-up attachment disposed adjacent the wrapping and positioned upon and connected to the inner peripheral surface of the wrapping.

FIG. 13 is a transverse view of FIG. 12 taken at 13-13, showing the placement of the decorative pop-up attachment adjacent the inner peripheral surface of the wrapping.

FIG. 14 is a perspective view of a second sheet of material, one edge being lifted for illustration purposes only.

FIG. 15 is a perspective view of a pot disposed upon the upper surface of the second sheet of material shown in FIG. 14.

FIG. 16 is a perspective view of the pot and the second sheet of material of FIGS. 14-15, but showing the pot being partially wrapped by the second sheet of material.

FIG. 17 is a perspective view of the pot and second sheet of material of FIGS. 14-16, but showing the second sheet of material forming a pot wrapping about the pot, and showing a decorative popup attachment spaced a distance away.

FIG. 18 is a perspective view of the pot wrapped by the pot wrapping of FIG. 17, but showing the decorative pop-up attachment disposed adjacent to the outer peripheral surface of the pot wrapping and positioned upon and connected thereto.

FIG. 19 is a perspective view of the pot wrapped by the pot wrapping of FIG. 17, but showing the decorative pop-up attachment disposed adjacent to the inner peripheral surface of the pot wrapping and positioned upon and connected thereto.

FIG. 20 is a transverse view of FIG. 19 taken at 20-20, showing the placement of the decorative pop-up attachment adjacent the inner peripheral surface of the pot wrapping.

FIG. 21 is a perspective view of a preformed flower pot cover.

FIG. 22 is a perspective view of a preformed flower pot cover, having a pot disposed into the retaining space, and showing a decorative pop-up attachment spaced a distance therefrom.

FIG. 23 is a perspective view of the preformed flower pot cover having a pot disposed therein of FIG. 22, but showing the decorative pop-up attachment being disposed adjacent to the outer peripheral surface of the preformed flower pot cover and positioned upon and connected thereto.

FIG. 24 is a perspective view of the preformed flower pot cover having a pot disposed therein of FIG. 22, but showing the decorative pop-up attachment being disposed adjacent to the inner peripheral surface of the preformed flower pot cover and positioned upon and connected thereto.

FIG. 25 is a transverse view of FIG. 24 taken at 25-25, showing the placement of the decorative pop-up attachment adjacent the inner peripheral surface of the preformed flower pot cover.

FIG. 26 is a perspective view of a floral grouping having a flower portion and a stem portion, and having a decorative pop-up attachment disposed in the center of the flower portion of the floral grouping.

FIG. 27 is a top plan view of the floral grouping and decorative pop-up attachment shown in FIG. 26.

### DETAILED DESCRIPTION OF THE INVENTION

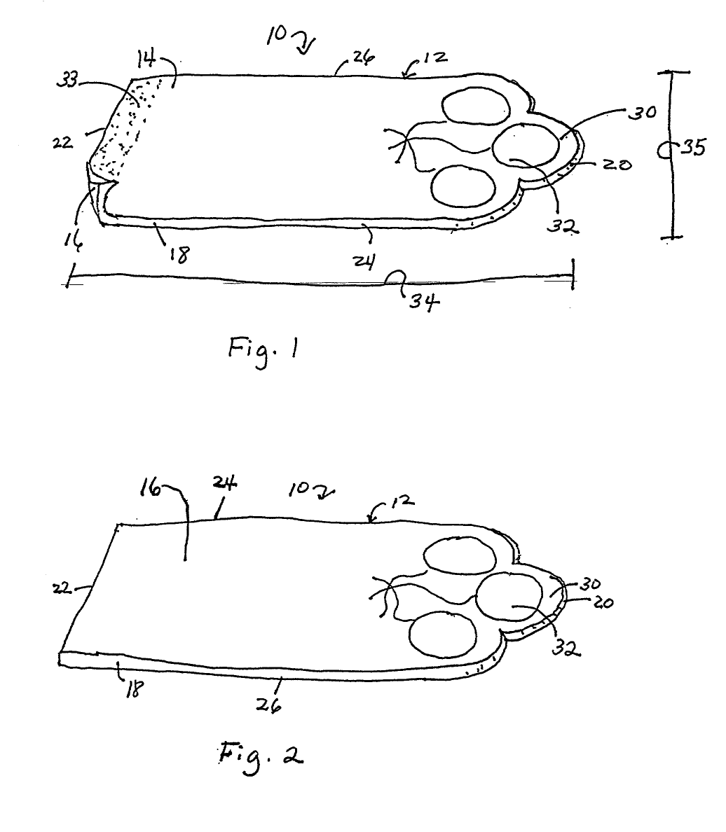

### The Embodiments of FIGS. 1-2

Referring to FIGS. 1-2, designated generally by the reference numeral 10 is a decorative pop-up attachment which is constructed in accordance with the present invention. The decorative pop-up attachment 10 comprises at least one sheet of material 12. The sheet of material 12 has an upper surface 14, a lower surface 16 (one edge of the sheet of material lifted for illustration purposes only), and an outer periphery 18. In the embodiment shown in FIG. 1, the outer periphery 18 of the sheet of material 12 comprises a first side 20, a second side 22, a third side 24, and a fourth side 26. It will be appreciated that the sheet of material 12 may comprise a variety of shapes, and sides.

At least one portion of the sheet of material will form a decorative end 30. It will be appreciated, however, that the sheet of material 12 may have more than one decorative end 30, that is, a plurality of decorative ends 30. One such decorative pop-up attachment with at least one decorative end is shown in U.S. Pat. No. 5,544,469, entitled “Wrapping Material Having An Extension For Design Indicia For Wrapping Flower Pots And Floral Arrangements And Methods”, issued to Weder et al., on Aug. 13, 1996, which is hereby specifically incorporated by reference herein. It will be understood, however, for illustrative purposes only, that only one decorative end 30 is shown herein. The decorative end 30 comprises design indicia 32 on at least one surface thereof. The design indicia 32 may be on the upper surface 14, the lower surface 16, or both the upper surface 14 and the lower surface 16 (FIGS. 1-2). “Design indicia” as used herein includes, but not by way of limitation, fanciful designs such as rabbits, hearts, balloons, pumpkins, clover, and the like. Additional examples of design indicia include flowers (such as roses, daisies, lilacs), plants (such as fruits, vegetables, clover, grasses, trees), animals (rabbits, dogs, cats, birds, alligators, fish and the like), insects, fictional characters (such as cartoon characters), and/or real characters (such as a photograph of an individual), and the like. Design indicia 32 may vary between the upper surface 14 and the lower surface 16 of the sheet of material 12 (FIGS. 1-2). That is, either the upper surface 14, or, alternatively, the lower surface 16, or, in another alternative, both surfaces, may have design indicia 32 thereon. In addition, the upper surface 14 and the lower surface 16 may each have different design indicia 32 disposed on each surface.

The design indicia 32 may be disposed upon the sheet of material 12 by use of a dye, ink, and/or pigment. Such dyes, inks, and/or pigments are known in the art and are commercially available, and may be disposed upon or incorporated in the sheet of material 12 by any method described herein or known in the art. That is, the design indicia 32 may be painted upon the sheet of material 12, sprayed upon the sheet of material 12, printed upon the sheet of material 12, or incorporated in the sheet of material 12 during the extrusion process. The extrusion of polymer films is well-known in the art.

The sheet of material 12 may closely follow the design indicia 32, and be complementary to the shape of at least a portion of the design indicia. In this manner, the sheet of material 12 forms at least a portion of the design indicia 32 by following the outline of the design indicia 32. Alternatively, the sheet of material 12 may not follow the outline of the design indicia 32, and may form its own geometric, non-geometric and/or asymmetric shape.

A bonding material 33 may, optionally, be disposed on the sheet of material 12, on either the upper surface 14 (FIG. 1), the lower surface 16, or both surfaces. Alternatively, however, the sheet of material 12 may be free of a bonding material 33. As illustrated in FIG. 1, the bonding material 33, if present, is often disposed on the upper surface 14 of the sheet of material 12. The bonding material 33 may also be disposed in a strip of bonding material 33, although the bonding material 33 also could be applied to a surface of the sheet of material 12 be in the form of spaced apart spots or the bonding material 33 may be disposed on one or more surfaces of the sheet of material 12 in any geometric shape, non-geometric and/or asymmetric shape, or any combination thereof, including any pattern or plurality of patterns. Further, the bonding material 33 may form at least a part, or, alternatively, all of the pattern on each strip of material. In this instance, the bonding material 33 may comprise one or more colors; the bonding material 33 may comprise one or more patterns as well, as described above, and could form a part of the design indicia 32. One such bonding material is described in U.S. Pat. No. 5,517,802, entitled, “Sticky Element Upon Which Insects Adhere And Materials And Methods”, issued to Donald E. Weder, on May 21, 1996 and which is hereby incorporated herein by reference.

Turning to the characteristics of the sheet of material 12, the sheet of material 12 has a thickness in a range from about 0.5 mils to about 50 mils. Often, the sheet of material 12 has a thickness in a range from about 1.0 mils to about 30 mils. In some embodiments, the sheet of material has a thickness in a range from about 3.0 mils to about 25 mils. In other embodiments, the sheet of material has a thickness in a range from about 4 mils to about 15 mils. And in yet still another embodiment, the sheet of material has a thickness in a range from about 4 mils to about 10 mils. The sheet of material 12 is constructed of a material which is at least somewhat flexible.

The sheet of material 12 may comprise any shape or combination of shapes, and a portion of a rectangular shape is shown in FIG. 1 only by way of example. The sheet of material 12 for example may be square, rectangular, circular or any other geometric, non-geometric, asymmetric or fanciful shape, such as heart shaped, for example only, or any combination of geometric and non-geometric shapes, as shown in FIGS. 1-2. The sheet of material 12 may be constructed of a single layer of material or a plurality of layers of the same or different types of materials. The layers of material comprising the sheet of material 12 may be laminated together or connected together by any method known in the art.

In one embodiment, the sheet of material 12 is a relatively thin, flexible material constructed from a plastic film. Alternatively, a paper may be utilized, alone, or in combination with other sheets of material described herein. One such plastic film (Hercules B523 oriented polypropylene packaging film (clear)), is available from Hercules Incorporated, Hercules Plaza, Wilmington, Del. 19894. Such sheets of material may be laminated together or may be connected together by any method known in the art, or may remain partially or completely unconnected. The sheet of material 12 shown in FIGS. 1-2 is constructed from any suitable material that is capable of having the characteristics and function described herein. The sheet of material 12 may comprise paper (the term “paper” as used herein means treated or untreated paper, corrugated paper or cardboard or any other form of paper material). The sheet of material may comprise cellophane, foil, plastic film, metallized film, fabric (woven or nonwoven or synthetic or natural), fiber, burlap, or any combination thereof.

The term “plastic film” as used herein means a thermo-plastic resinous material, such as, but not by way of limitation, a manmade polymer such as, but not by way of limitation, a polypropylene. The term “plastic film” as used herein also means a naturally occurring polymer such as cellophane. A plastic film, as contemplated and described in detail herein, is relatively strong and not as subject to tearing (substantially non-tearable), as might be the case with paper or foil.

The sheet of material 12 has a length 34 extending between the first and second sides 20 and 22 of the sheet of material 12. The sheet of material 12 also has a width 35 extending between the third and fourth sides 24 and 26 of the sheet of material 12.

The sheet of material 12 may be constructed of a single layer of material or a plurality of layers of the same or different types of materials. One or more sheets of material may be laminated or bonded together, completely or partially, by any method known in the art. When multiple sheets of material 12 are used, the sheets of material 12 need not be uniform in size or shape. That is, one sheet may extend beyond at least a portion of the outer periphery of another sheet of material.

As noted earlier, a bonding material 33 may be disposed on the sheet of material 12, in any pattern or shape. One method for disposing a bonding material, in this case an adhesive, on a sheet of material is described in U.S. Pat. No. 5,111,637 entitled “Method For Wrapping A Floral Grouping” issued to Weder et al., on May 12, 1992 and which is hereby incorporated herein by reference. Another method for disposing a bonding material in order to laminate two sheets of material is described in U.S. Pat. No. 4,297,811 entitled “Laminated Printed Foil Flower Pot Wrap With Multicolor Appearance”, issued to Weder on Nov. 3, 1981, which is also hereby incorporated herein by reference.

The term “bonding material” when used herein means an adhesive, possibly a pressure sensitive adhesive, or a cohesive. Where the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” when used herein also means a lacquer, which may be applied to the sheet of material and, in this instance, heat, sound waves, or vibrations, also must be applied to effect the sealing of the lacquer. The term “bonding material” when used herein also means any type of material or thing which can be used to effect the bonding or connecting of the two adjacent portions of the material or sheet of material to effect the connection or bonding described herein. The term “bonding material” also includes ties, labels, bands, ribbons, strings, tape, staples or combinations thereof. Some of the bonding materials would secure the ends of the sheet of material while other bonding material may bind the circumference of a wrapper or wrapping. Another way to secure the wrapping is to heat seal the ends of the material to another portion of the material. One way to do this is to contact the ends with an iron of sufficient heat to heat seal the material.

The term “bonding material” when used herein also means any heat or chemically shrinkable material, and static electrical or other electrical means, magnetic means, mechanical or barb-type fastening means or clamps, curl-type characteristics of the film or materials incorporated in the sheet of material which can cause the material to take on certain shapes, and any type of welding method which may weld portions of the sheet to itself or to a pot or container, or to both the sheet itself and a pot or container.

The sheet of material 12 may consist of designs or decorative patterns which are printed, etched, and/or embossed thereon using inks or other printing materials. An example of an ink which may be applied to either surface of the sheet of material 12 is described in U.S. Pat. No. 5,147,706 entitled “Water Based Ink On Foil And/Or Synthetic Organic Polymer”; issued to Kingman on Sep. 15, 1992 and which is hereby incorporated herein by reference. In addition, the sheet of material 12 may have various colorings, coatings, embossings, flockings and/or metallic finishes, or other decorative surface ornamentation applied separately or simultaneously. The sheet of material 12 may be characterized totally or partially, but not by way of limitation, by pearlescent, translucent, transparent, iridescent, neon, holographic, or the like, qualities. Each of the above-named characteristics may occur alone or in combination with other characteristics described herein, and may be applied to the upper and/or lower surface of the sheet of material 12. Moreover, each surface of the sheet of material 12 may vary in the combination of such characteristics. The sheet of material 12 may also be partially or completely opaque, translucent, clear and/or tinted transparent.

The sheet of material 12 may also optionally comprise one or more shape sustaining elements (not shown). “Shape sustaining elements” means wire or rods, or other elements made from metal, plastic (synthetic resinous plastic), cardboard or other thickened paper product, fiber, wood, or a combination thereof, which imparts sufficient shape to permit the sheet of material 12 to extend a distance from a floral wrapping, a pot or container and/or a preformed flower pot cover, as described in greater detail below. Such a shape sustaining element (not shown) may be attached to the sheet of material 12 via a bonding material, the element laminated between sheets of material 12, or by any method described herein or known in the art. It will be understood that the shape sustaining element may be used to bend and shape the decorative pop-up attachment 10. The shape sustaining element may be utilized to form the decorative pop-up attachment 10 into a shape which is complementary to the design indicia 32 contained thereon. The shape sustaining element may also be utilized to extend the decorative pop-up attachment 10 a distance from the item to which it is attached.

When the decorative pop-up attachments 10 are used, one or more of the decorative pop-up attachment 10 is connectable to a pot or container, a wrapping for flowers (a sheet of material or a sleeve), a wrapping for a pot or container, or a preformed flower pot cover. Each decorative pop-up attachment 10 will extend a distance from the pot/container, the wrapping (for a floral grouping or a pot/container), or the preformed flower pot cover, so that the design indicia 32 on the decorative end 30 may be displayed. In many instances, each decorative pop-up attachment 10 will extend a substantial distance from the pot/container, the wrapping (for a floral grouping or a pot/container), or the preformed flower pot cover. Each of these applications is discussed in detail below.

The decorative pop-up insert 10 may also comprise an area for a hand-written or, alternatively, a printed message. Such an area may permit a personalized, written message (not shown).

Alternatively, however, such an area may have a pre-printed message (not shown). In yet another alternative, the decorative pop-up insert 10 may have a connecting portion (not shown) on the sheet of material 12 where a card or small sheet of material having a message, whether hand-written or pre-printed, could be connected-to the decorative pop-up attachment 10. Such a connecting portion may be formed by bonding material, by a slot (not shown) in the decorative pop-up attachment, or by any means and/or method known in the art. One such similar decorative pop-up attachment with an area for permitting a written or pre-printed message, or the attachment of a message, is disclosed in U.S. Pat. No. 5,544,469, entitled “Wrapping Material Having An Extension For Design Indicia For Wrapping Flower Pots And Floral Arrangements And Methods”, issued to Weder et al., on Aug. 13, 1996, which has been previously incorporated by reference herein.

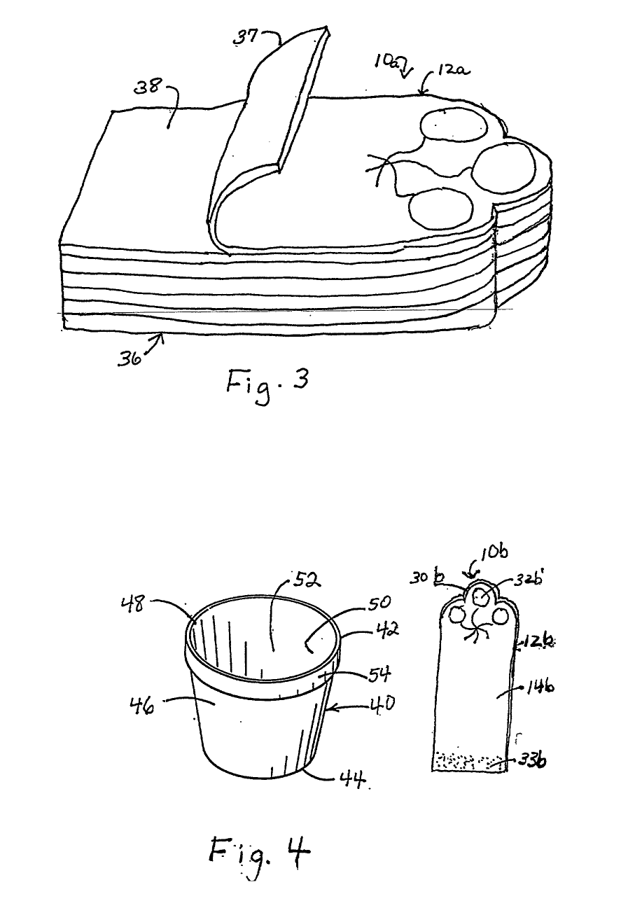

### Embodiment of FIG. 3

Shown in FIG. 3 is a modified decorative pop-up attachment 10a formed from a sheet of material 12a which is identical to the decorative pop-up attachment 10 and sheet of material 12 shown in FIGS. 1-2 and described in detail previously, except that the sheet of material 12a is formed into a group of sheets of material 12a which are stacked and aligned, generally, but not by way of limitation, one on top of the other to form a pad 36 of sheets of material 12a.

The pad 36 comprises a top sheet 37 having a next sheet 38 disposed directly thereunder, with additional sheets of material 12a disposed under the next sheet 38, all sheets collectively forming the pad 36 of sheets of material 12a (one edge of the top sheet 37 lifted for illustration purposes only). The sheets of material 12a are generally aligned, and may, optionally, but not by way of limitation, be connected together via a bonding material (not shown), such as, but not by way of limitation, a pressure sensitive adhesive.

It will be appreciated that the decorative pop-up attachment 10a may also be provided via a roll of sheets of material 12a (not shown). Such a roll may provide one, or a plurality, of decorative pop-up attachments 10a (not shown). Such a plurality of decorative pop-up attachments 10a would likely be separated by perforations, permitting each one to be easily separated from the roll (not shown). Alternatively, a plurality of decorative pop-up attachments 10a contained within a roll of decorative pop-up attachments 10a would be easily separated from a roll via a dispenser having a cutting edge (not shown).

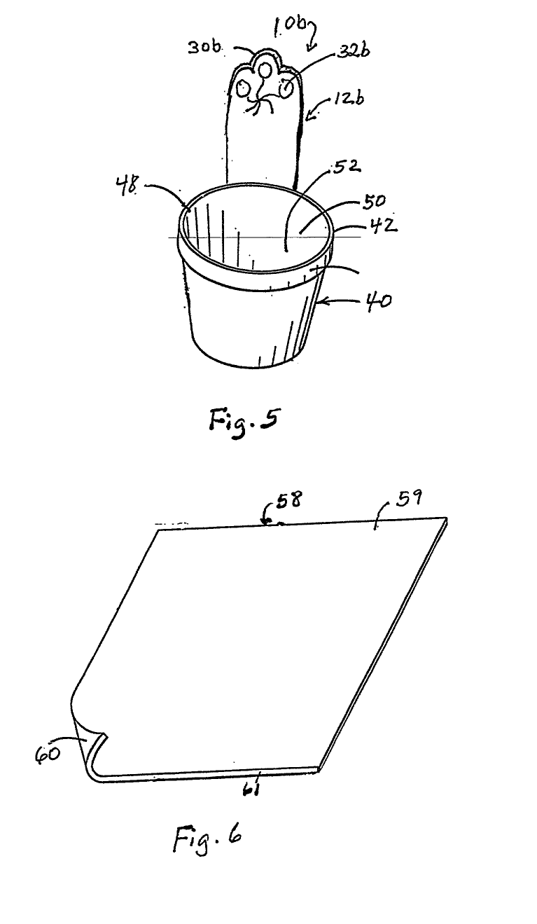

### The Embodiments and Methods of FIGS. 4-5

Shown in FIG. 5 is a decorative pop-up attachment 10b constructed from a sheet of material 12b, which is exactly like the decorative pop-up attachment 10 and the sheet of material 12, except that the decorative pop-up attachment 10b is disposed on and connected to a pot 40.

The flower pot 40, illustrated in FIG. 4, comprises an upper end 42, a lower end 44 and an outer peripheral surface 46. The upper end 42 has an opening 48 that is formed in the flower pot 40, with a portion of the flower pot opening 48 intersecting the upper end 42 of the flower pot 40 forming an inner peripheral surface 50 and a retaining space 52. A rim 54, namely a thickened “collar,” surrounds the opening 48, and extends circularly around the upper end 42 of the flower pot 40. The flower pot opening 48 is sized and shaped for receiving a floral grouping, the floral grouping being retained in the retaining space 52 of the flower pot 40 (not shown).

The term “flower pot” means any type of container used to hold a floral grouping. Examples of flower pots 40 used in accordance with the present invention include clay flower pots, plastic flower pots, fiber flower pots, metal pots, paper mache pots, glass flower pots, baskets, and any combination thereof.

In a method of use, as shown in FIG. 5, the decorative pop-up attachment 10b is disposed adjacent the outer peripheral surface 46 of the pot 40. The decorative pop-up attachment 10b is positioned upon the outer peripheral surface 46 of the pot 40, and connected to the outer peripheral surface 46 of the pot 40 via a bonding material 33b. When the decorative pop-up attachment 10b is connected to the pot 40 as described previously, the decorative pop-up attachment 10b extends a distance from the pot 40.

It will be understood that, alternatively, the decorative popup attachment 10b could be disposed adjacent the inner peripheral surface 50 of the pot 40, and positioned thereon and connected thereto (not shown). It will be appreciated that when the decorative pop-up attachment 10b is disposed adjacent the inner peripheral surface 50 of the pot 40, the decorative pop-up attachment may be held in place via bonding material which connects to the pot (not shown), or, alternatively, by a frictional engagement between the inner peripheral surface 50 of the pot 40 and any growing medium and/or floral grouping and/or other material contained in the pot 40 (not shown), or, in another alternative, by any other means or method known in the art.

### The Embodiments and Methods of FIGS. 6-9

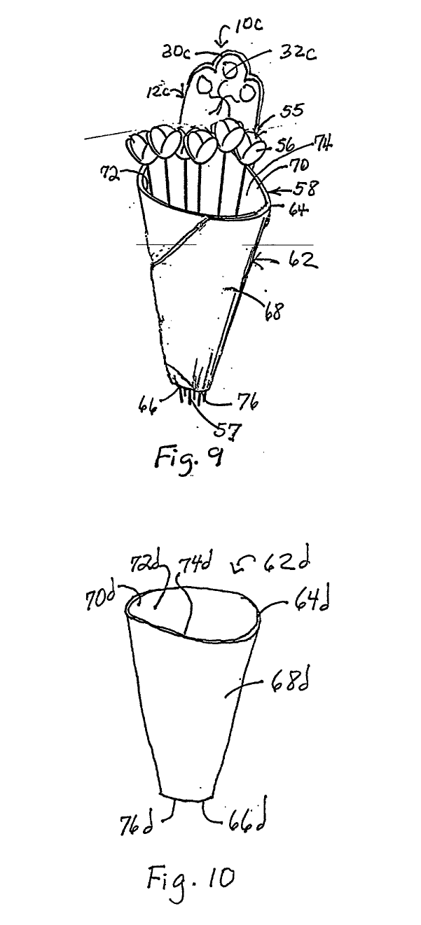

Shown in FIGS. 8-9 is a decorative pop-up attachment 10c constructed from a sheet of material 12c, which is exactly like the decorative pop-up attachment 10 and the sheet of material 12, except that the decorative pop-up attachment 10c is disposed on and connected to a wrapping containing a floral grouping 55.

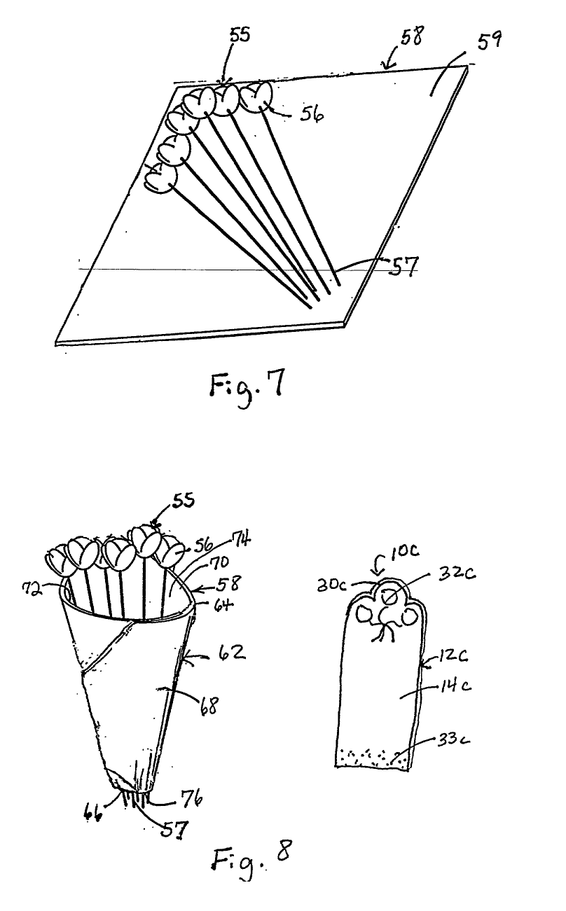

“Floral grouping”, as shown best herein in FIG. 7 and as used herein and means fresh cut flowers, artificial flowers, other fresh and/or artificial plants or other floral materials and may include other secondary plants and/or ornamentation which add to the aesthetics of the overall floral grouping 55. The floral grouping 55 comprises a flower portion 56 which may comprise either a bloom or foliage portion and a stem portion 57. However, it will be appreciated that the floral grouping 55 may consist of only a single bloom or only foliage (not shown). “Floral grouping” as used also includes any living plant which is contained within a flower pot as described herein. Such a floral grouping 55 may include, as well as a flower portion 56 and a stem portion 57, a root portion contained in a growing medium or other material (not shown).

As mentioned previously, the floral grouping 55 may be wrapped or held in a wrapping. The wrapping may be formed from a floral wrapping sheet of material 58 wrapped about the floral grouping 55, as shown in FIGS. 6-8. Such a floral wrapping sheet of material 58, as shown in FIGS. 6-7, has an upper surface 59, a lower surface 60 and an outer periphery 61. It will be understood that the floral wrapping sheet of material 58 has the same or similar characteristics as those previously described herein for the sheet of material 12 which forms the decorative pop-up attachment 10.

In a method of forming a wrapping utilizing a floral wrapping sheet of material 58, a floral grouping 55 is disposed on the floral wrapping sheet of material 58, as shown in FIG. 7. At least one portion of the floral wrapping sheet of material 58 is overlapped over at least one other portion of the floral wrapping sheet of material 58, as shown in FIG. 8, thereby forming a wrapping 62. It will be appreciated that the floral wrapping sheet of material 58 may, optionally, have a bonding material disposed thereon (not shown), to secure the floral wrapping sheet of material 58 in the wrapped position. One method of forming a wrapping about a floral grouping is described in U.S. Pat. No. 5,181,364, entitled “Wrapping A Floral Grouping With Sheets Having Adhesive Or Cohesive Applied Thereto”, issued to Weder on Jan. 26, 1993, which is hereby incorporated herein by reference.

The wrapping 62 has an upper end 64, a lower end 66 and an outer peripheral surface 68. An opening 70 intersects the upper end 64 forming an inner peripheral surface 72 and a retaining space 74. The floral grouping 55 is retained in the retaining space 74 of the wrapping 62. The opening 70 also intersects the lower end 66, forming a lower opening 76, from which the stem portion 57 of the floral grouping 55 extends. Alternatively, it will be appreciated that the lower end 66 of. the wrapping 62 is closed (not shown). Further, it will be understood that the upper end of the wrapping 62 may also be closed (not shown).

In a method of use, the decorative pop-up attachment 10c is disposed adjacent the outer peripheral surface 68 of the wrapping 62. The decorative pop-up attachment 10c is positioned upon the outer peripheral surface 68 of the wrapping 62, and is then connected to the outer peripheral surface 68 of the wrapping 62 via the bonding material 33c. When connected to the wrapping 62, the decorative pop-up attachment 10c extends a distance from the wrapping 62.

It will be understood that the decorative pop-up attachment 10c could be disposed adjacent to the inner peripheral surface 72 of the wrapping 62, and positioned thereon and connected thereto (not shown). In this instance, the decorative pop-up attachment 10c is connected to the inner peripheral surface 72 of the wrapping 62 via the bonding material 33c, or, alternatively, via a frictional engagement between the floral grouping 55, the decorative pop-up attachment 10c and the inner peripheral surface 72 of the wrapping 62, or, in another alternative, between overlapping folds of the floral wrapping sheet of material 58 which forms the wrapping 62. It will be appreciated that the decorative pop-up attachment 10c in these embodiments (not shown) extends a distance from the wrapping 62 (not shown). It will be appreciated that the wrapping 62 may, alternatively, be crimped about the stem portion 57 or any other portion of the floral grouping 55 (not shown). Such crimping or gathering permits the wrapping 62 to closely engage the stem portion 57 or other portion of the floral grouping 55 (not shown).

### The Embodiments and Methods of FIGS. 10-13

Shown in FIGS. 11-13 is a decorative pop-up attachment 10d constructed from a sheet of material 12d, which is exactly like the decorative pop-up attachment 10 and the sheet of material 12, except that the decorative pop-up attachment 10d is disposed on and connected to a sleeve which forms a wrapping 62d containing a floral grouping 55d.

Such a sleeve may be formed from a continuous web, may be formed from one sheet of material, may be formed from two sheets of material, or may be formed from a plurality of sheets of material. The sleeve remains in a flattened state when not in use. To use the sleeve described herein, the sleeve must be opened and held open to permit the sleeve to form a retaining space for a floral grouping. It will be understood that the sheets of material forming sleeves have the same or similar characteristics as those described herein for sheets of material.

In the present instance, but not by way of limitation, the sleeve utilized as a wrapping 62d herein is preformed from a continuous web, and has an upper end 64d, a lower end 66d and an outer peripheral surface 68d. When the sleeve is unflattened, as shown in FIG. 10, an opening 70d intersects the upper end 64d forming an inner peripheral surface 72d and a retaining space 74d. Such sleeves are disclosed in both U.S. Pat. No. 5,572,851, entitled “Plant Package Having A Detachable Sleeve And Methods”, issued to Weder, Nov. 12, 1996, and U.S. Pat. No. 5,625,979, entitled “Sleeve Having A Detachable Portion Forming A Skirt And Methods”, issued to Weder, May 6, 1997, which are hereby incorporated by reference herein.

It will be appreciated, as shown in FIGS. 11-13, that a floral grouping 55d is disposed in the retaining space 74d. The opening 70d usually also intersects the lower end 66d, forming a lower opening 76d in the wrapping 62d as well. Often when there is a lower opening 76d, such as illustrated herein (FIGS. 11-13), the stem portion 57d of the floral grouping 55d extends therethrough. Alternatively, the lower end 66d may be closed (not shown). In a further alternative, the upper end 64d of the wrapping 62d may also be closed (not shown).

In a method of use, as shown in FIGS. 10-11, the floral grouping 55d is disposed into the wrapping 62d, with the stem end 57d disposed into the opening 70d in the upper end 64d of the wrapping 62d. The floral grouping 55d is retained in the retaining space 74d, and the flower portion 56d of the floral grouping 55d is disposed adjacent and/or near the upper end 64d of the wrapping 62d, while the stem portion 57d of the floral grouping 55d extends through the lower opening 76d.

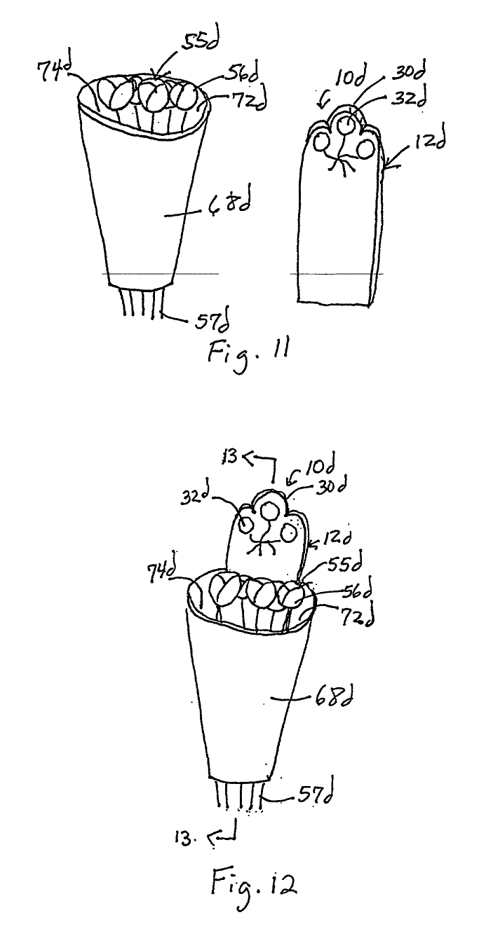

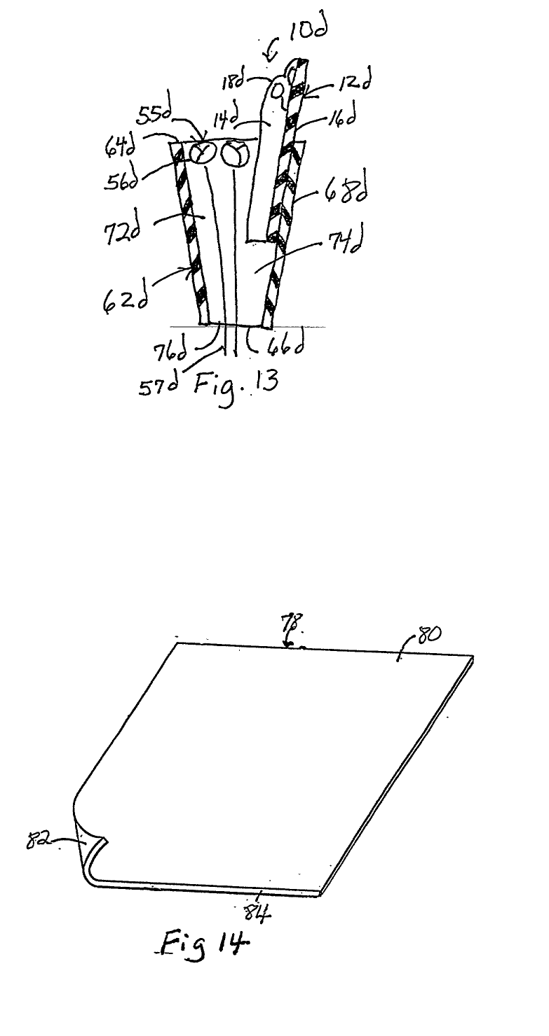

As illustrated in FIGS. 11-13, the decorative pop-up attachment 10d is disposed adjacent the inner peripheral surface 72d of the wrapping 62d. The decorative pop-up attachment 10d is positioned upon the inner peripheral surface 72d of the wrapping 62d, and is then connected to the inner peripheral surface 72d of the wrapping 62d (FIGS. 12-13) via a bonding material, or, alternatively, via a frictional engagement between the inner peripheral surface 72d of the wrapping 62d, the decorative pop-up attachment 10d and the floral grouping 55d (not shown), or in another alternative, by any means and/or method known in the art. When connected to the wrapping 62d, the decorative pop-up attachment 10d extends a distance from the wrapping, 62d.

It will be understood that the decorative pop-up attachment 10d could be disposed adjacent to the outer peripheral surface 68d of the wrapping 62d, and positioned thereon and connected thereto via the bonding material 33d, or by any other means or method shown and/or described herein, or known in the art (not shown). In this instance as well, the decorative pop-up attachment 10d extends a distance from the wrapping 62d (not shown).

It will be appreciated that the wrapping 62d may, alternatively, be crimped about the stem portion 57d or any other portion of the floral grouping 55d (not shown). Such crimping or gathering permits the wrapping 62d to closely engage the stem portion 57d or other portion of the floral grouping 55d (not shown).

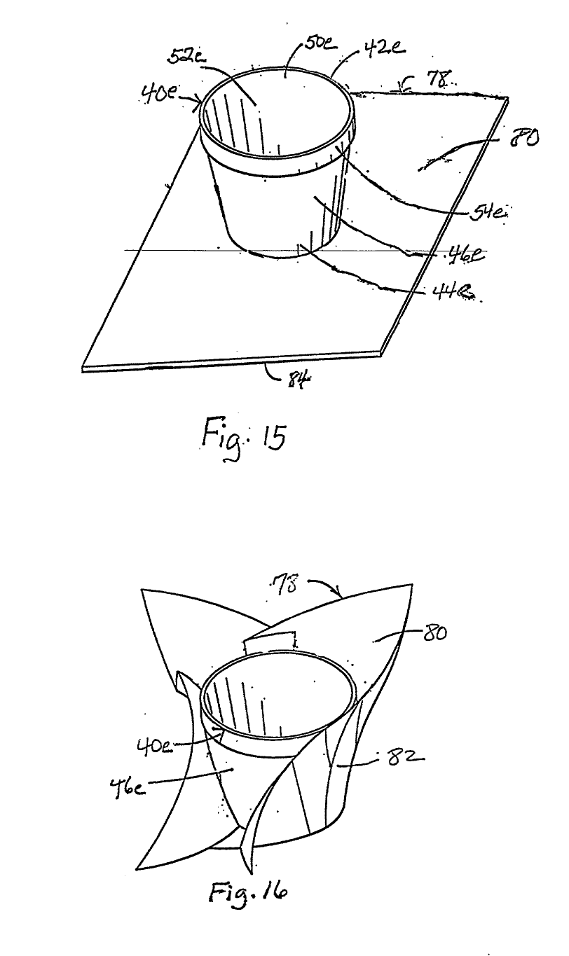

### The Embodiments and Methods of FIGS. 14-20

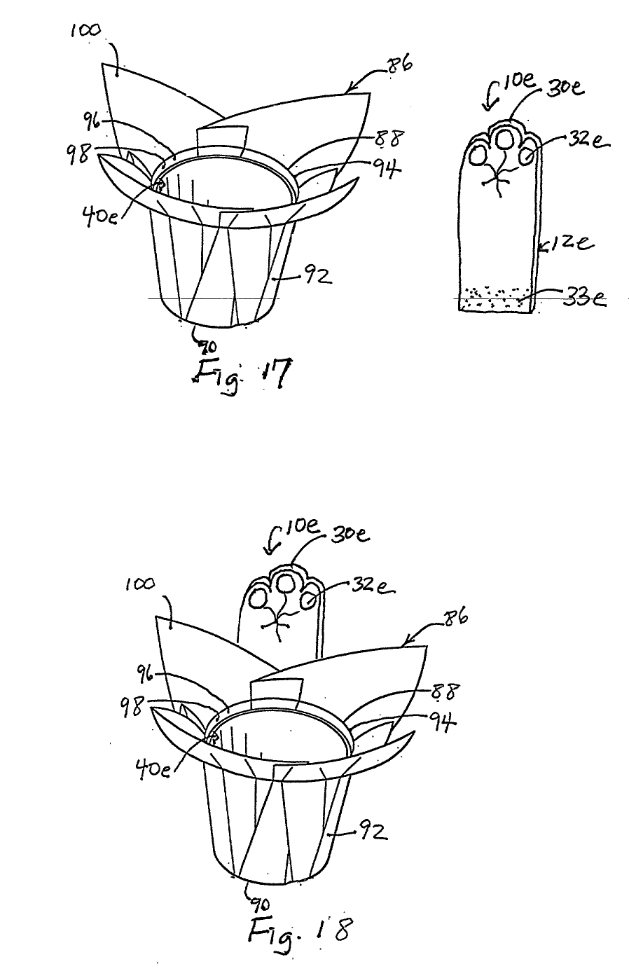

Shown in FIG. 17-20 is a decorative pop-up attachment 10e constructed from a sheet of material 12e, which is exactly like the decorative pop-up attachment 10 and the sheet of material 12, except that the decorative pop-up attachment 10e is disposed on-and connected to a sheet of material forming a pot wrapping, which is wrapped about a pot 40e.

The pot wrapping is formed from a second sheet of material 78, FIG. 14, which is sized to wrap a pot 40e. It will be appreciated that the second sheet of material 78 has all of the characteristics described earlier for the sheet of material 12.

The second sheet of material 78 has an upper surface 80, a lower surface 82 and an outer periphery 84. The second sheet of material 78 may or may not having a bonding material thereon (not shown).

In a method of use, a pot 40e is disposed on one surface, in this example, but not by way of limitation, the upper surface 80 of It the second sheet of material 78. The second sheet of material 78 is wrapped by an operator about the outer peripheral surface 46e of the pot 40e, forming the pot wrapping 86. One such pot wrapping is shown in U.S. Pat. No. 5,111,638, entitled “Method For Wrapping An Object With A Material Having Pressure Sensitive Adhesive Thereon”, issued to Weder, May 12, 1992, which is hereby incorporated by reference.

The pot wrapping 86, when formed, has an upper end 88, a lower end 90 and an outer peripheral surface 92. An opening 94 intersects the upper end 88 of the pot wrapping 86 forming an inner peripheral surface 96 and a retaining space 98, which holds the pot 40e and which is adjacent the outer peripheral surface 46e of the pot 40e. Optionally, the pot wrapping 86 may also have a skirt 100 which extends from the upper end 88 of the pot wrapping 86, as shown in FIGS. 17-20.

The decorative pop-up attachment 10e is shown, in FIGS. 175 18, to be disposed adjacent the outer peripheral surface 92 of the pot wrapping 86 via a bonding material, or via any other means and/or method shown and/or described herein, or known in the art. The decorative pop-up attachment 10e, when disposed adjacent the outer peripheral surface of the pot wrapping 86, is positioned on the pot wrapping 86 then connected to the pot wrapping 86 via a bonding material 33e, or via any other means or method known in the art. When the decorative pop-up attachment 10e is positioned on and connected to the pot wrapping 86, the decorative pop-up attachment 10e extends a distance from the pot wrapping 86.

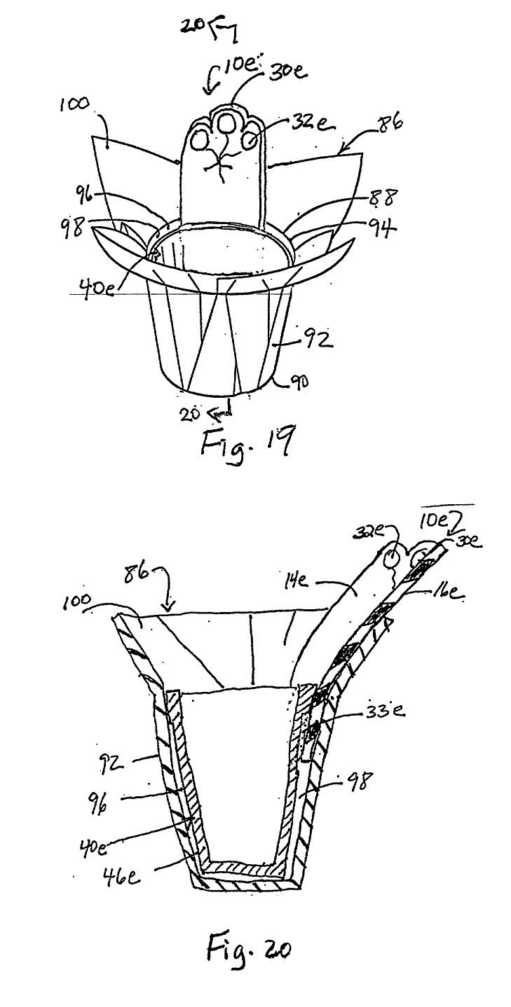

Alternatively, as shown in FIGS. 19-20, the decorative pop up attachment 10e may be disposed adjacent the inner peripheral surface 92 of the pot wrapping 86. In this instance, the decorative pop-up attachment 10e is usually disposed adjacent both the inner peripheral surface 92 of the pot wrapping and the outer peripheral surface 46e of the pot 40e. The decorative pop-up attachment 10e may be connected to the pot wrapping 86 via frictional engagement, a bonding material 33e, or any other means or method known in the art. When the decorative pop-up attachment 10e is positioned on and connected to the pot wrapping 86, the decorative pop-up attachment 10e extends a distance from the pot wrapping 86.

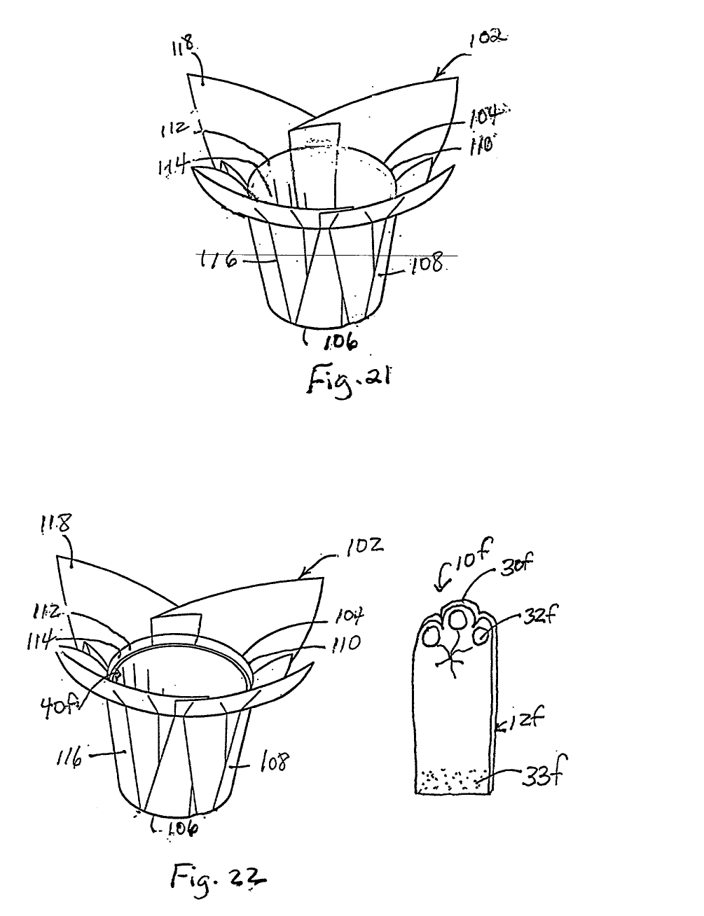

### The Embodiments and Methods of FIGS. 21-25

Shown in FIGS. 22-25 is a decorative pop-up attachment 16f constructed from a sheet of material 12f, which is exactly like the decorative pop-up attachment 10 and the sheet of material 12, except that the decorative pop-up attachment 10f is disposed on and connected to a preformed flower pot cover 102.

A preformed flower pot cover 102 is illustrated in FIG. 21. One such similar preformed flower pot cover is disclosed in U.S. Pat. No. 4,773,182, entitled “Article Forming System”, issued to Weder et al. on Sep. 27, 1988, and is hereby incorporated herein by referenced. The preformed flower pot cover 102 has an upper end 104, a lower end 106 and an outer peripheral surface 108. An opening 110 intersects the upper end 104 of the preformed flower pot cover 102 forming an inner peripheral surface 112 and a retaining space 114. The area between the upper end 104 and the lower end 106 of the preformed flower pot cover 102 is the base 116. Optionally, the preformed flower pot cover 102 may have a skirt 118 which extends from the upper end 104 of the base 116.

In a method of use, an operator disposes a pot 40f into the retaining space 114 of the preformed flower pot cover 102, as shown in FIG. 22. In this manner, the outer peripheral surface 46f of the pot 40f is adjacent the inner peripheral surface 112 of the preformed flower pot cover 102. It will be appreciated that the pot 40f, or any pot shown and described herein, may contain a floral grouping 55f.

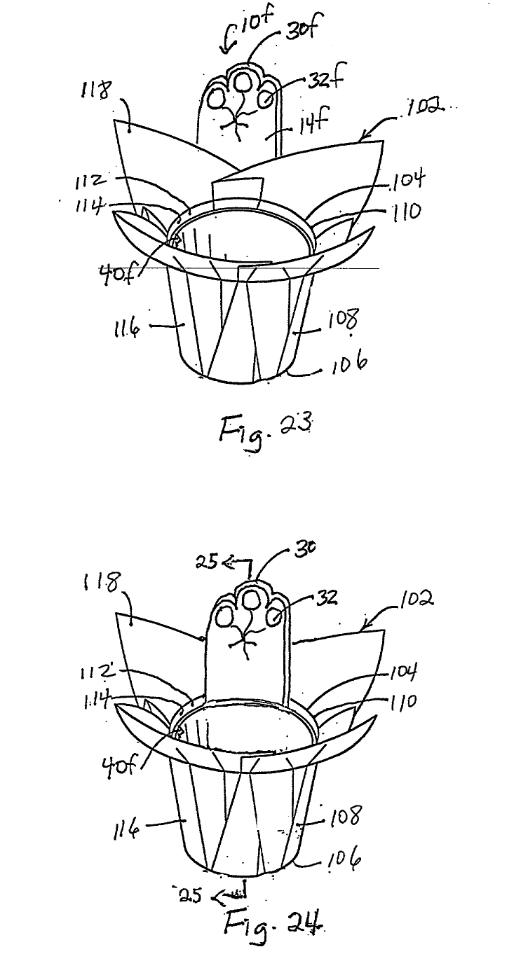

In a method of using the decorative pop-up attachment 10f, shown in FIGS. 22-23, the decorative pop-up attachment 10f is disposed adjacent the outer peripheral surface 108 of the preformed flower pot cover 102. The decorative pop-up attachment 10f when disposed adjacent the outer peripheral surface 108 of the preformed flower pot cover 102, is positioned upon the preformed flower pot cover 102 and connected to the preformed flower pot cover 102 via a bonding material 33f, or via any other means or method shown and/or described herein, or known in the art. When the decorative pop-up attachment 10f is positioned on and connected to the preformed flower pot cover 102, the decorative pop-up attachment 10f extends a distance from the preformed flower pot cover 102.

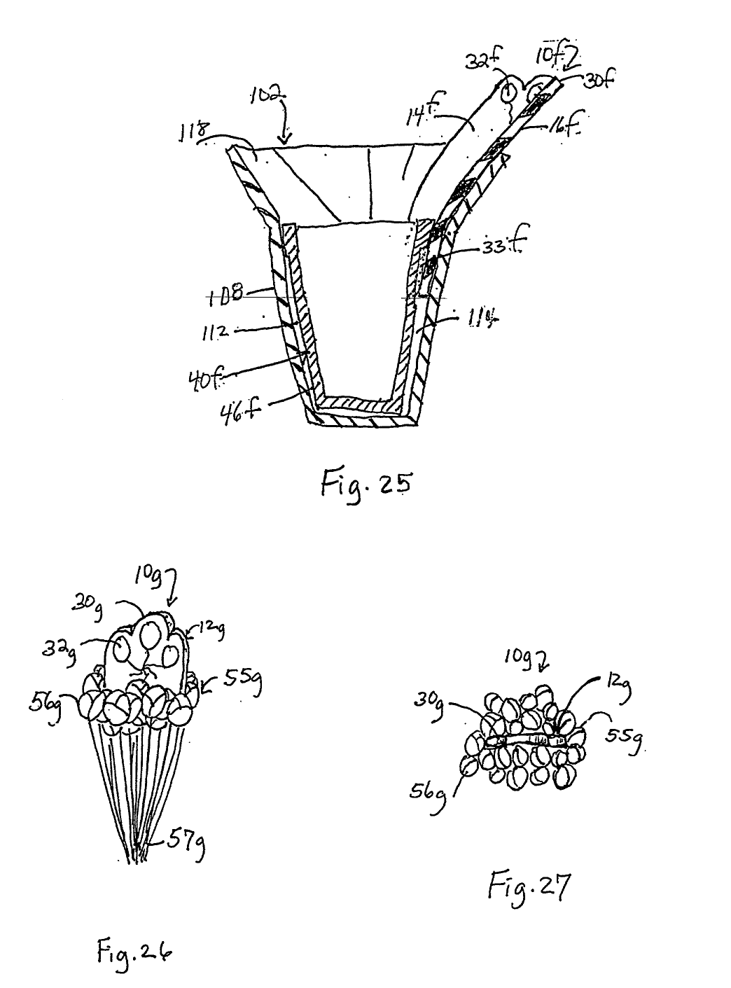

Alternatively, as illustrated in FIGS. 24-25, the decorative pop-up attachment 10f may be disposed adjacent the inner peripheral surface 112 of the preformed flower pot cover pot wrapping 86. In this instance, the decorative pop-up attachment 10f is usually disposed adjacent both the inner peripheral surface 92 of the preformed flower pot cover 102 and the outer peripheral surface 46f of the pot 40f. The decorative pop-up attachment 10f may be connected to the preformed flower pot cover 102 via frictional engagement, a bonding material 33f, or any other means and/or method shown and/or described herein, or known in the art. When the decorative pop-up attachment 10f is positioned on and connected to the preformed flower pot cover 102, the decorative pop-up attachment 10f extends a distance from the preformed flower pot cover 102.

### The Embodiments and Methods of FIGS. 26-27

Shown in FIGS. 26-27 is a decorative pop-up attachment 10g constructed from a sheet of material 12g, which is exactly like the decorative pop-up attachment 10 and the sheet of material 12, except that the decorative pop-up attachment 10g is disposed in the center of a floral grouping 55g.

The decorative pop-up attachment 10g is connected to any portion of the floral grouping 55g, that is, the flower portion 56g and/or the stem portion 57g, via a bonding material (not shown), or, alternatively, via a frictional engagement, or via any means or method known in the art. It will be appreciated that the floral grouping 55g may be disposed in a pot (not shown), or in a wrapping formed from either a floral wrapping sheet of material or a sleeve (not shown), or in a pot wrapped in a pot wrapping (not shown), or in a pot disposed in a preformed flower pot cover (not shown).

In a method of use, the decorative pop-up insert 10g is inserted into the center of the floral grouping 55g, as shown in FIGS. 26-27. The decorative pop-up insert 10g is disposed in the floral grouping 55g such that the decorative end 30g and the design indicia 32g thereon extends a distance away from the floral grouping 55g, and, particularly, a distance from the flower portion 56g of the floral grouping 55g.

Changes may be made in the construction and the operation of the various components, elements and assemblies described herein or in the steps or the sequence of steps of the methods described herein without departing from the spirit and scope of the invention as defined in the following claims.

What is claimed is:

1. A method for using a decorative pop-up attachment with a floral grouping, comprising the steps of:
providing a decorative pop-up attachment, comprising
a sheet of material having an outer periphery and having a decorative end having design indicia thereon, the sheet of material sized smaller than at least a portion of an outer diameter of a floral grouping, said floral grouping having a flower portion and a stem portion;
disposing the decorative pop-up attachment in the floral grouping;
positioning the decorative pop-up attachment in the floral grouping whereby the decorative end of the decorative pop-up attachment extends a distance away from the flower portion of the floral grouping for displaying design indicia on the decorative end; and
connecting the decorative pop-up extension to the floral grouping.

2. The method of claim 1 wherein in the step of providing a decorative pop-up attachment, the decorative pop-up attachment further comprises a bonding material.

3. The method of claim 2 wherein the bonding material comprises an adhesive bonding material.

4. The method of claim 2 wherein the bonding material comprises a cohesive bonding material.

5. The method of claim 1 wherein in the step of providing a decorative pop-up attachment, the sheet of material is constructed from a material selected from the group consisting of paper, cellophane, foil, plastic film, metallized film, fabric, fiber, burlap, and any combination thereof.

6. The method of claim 1 wherein in the step of providing a decorative pop-up attachment, the sheet of material has characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

7. The method of claim 1 wherein in the step of providing a decorative pop-up attachment, the sheet of material has a thickness in a range of about 0.5 mils to about 50 mils.

8. The method of claim 1 wherein in the step of providing a decorative pop-up attachment, the sheet of material has a thickness in a range of about 1.0 mils to about 30 mils.

9. The method of claim 1 wherein in the step of providing a decorative pop-up attachment, the sheet of material has a thickness in a range of about 3.0 mils to about 25 mils.

10. The method of claim 1 wherein in the step of providing a decorative pop-up attachment, the sheet of material has a thickness in a range of about 4 mils to about 15 mils.

11. The method of claim 1 wherein in the step of providing a decorative pop-up attachment, the sheet of material has a thickness in a range of about 4 mils to about 10 mils.

12. The method of claim 1 wherein in the step of disposing the decorative pop-up attachment in the floral grouping, the decorative pop-up attachment is further defined as being disposed adjacent at least a portion of the stem portion of the floral grouping.

13. The method of claim 1 wherein in the step of connecting the decorative pop-up attachment to the floral grouping, the decorative pop-up attachment is further defined as being connected to the floral grouping via a frictional engagement between the decorative pop-up attachment and the floral grouping.

14. The method of claim 1 wherein in the step of providing a decorative pop-up attachment, at least a portion of the outer periphery of the sheet of material adjacent the decorative end follows an outline of the design indicia such that the decorative end is complementary in shape to the design indicia thereon.

15. A method for using a decorative pop-up attachment, comprising the steps of:
providing a floral grouping having a flower portion and a stem portion, and having an outer diameter;
providing a decorative pop-up attachment, comprising
a sheet of material having an outer periphery and having a decorative end having design indicia thereon, the sheet of material sized smaller than at least a portion of the outer diameter of the floral grouping;
disposing the decorative pop-up attachment in the floral grouping;
positioning the decorative pop-up attachment in the floral grouping whereby the decorative end of the decorative pop-up attachment extends a distance away from the flower portion of the floral grouping for displaying design indicia on the decorative end; and
connecting the decorative pop-up attachment to the floral grouping.

16. The method of claim 15 wherein in the step of providing a decorative pop-up attachment, the decorative pop-up attachment further comprises a bonding material.

17. The method of claim 16 wherein the bonding material comprises an adhesive bonding material.

18. The method of claim 16 wherein the bonding material comprises a cohesive bonding material.

19. The method of claim 15 wherein in the step of providing a decorative pop-up attachment, the sheet of material is constructed from a material selected from the group consisting of paper, cellophane, foil, plastic film, metallized film, fabric, fiber, burlap, and any combination thereof.

20. The method of claim 15 wherein in the step of providing a decorative pop-up attachment, the sheet of material has characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

21. The method of claim 15 wherein in the step of providing a decorative pop-up attachment, the sheet of material has a thickness in a range of about 0.5 mils to about 50 mils.

22. The method of claim 15 wherein in the step of providing a decorative pop-up attachment, the sheet of material has a thickness in a range of about 1.0 mils to about 30 mils.

23. The method of claim 15 wherein in the step of providing a decorative pop-up attachment, the sheet of material has a thickness in a range of about 3.0 mils to about 25 mils.

24. The method of claim 15 wherein in the step of providing a decorative pop-up attachment, the sheet of material has a thickness in a range of about 4 mils to about 15 mils.

25. The method of claim 15 wherein in the step of providing a decorative pop-up attachment, the sheet of material has a thickness in a range of about 4 mils to about 10 mils.

26. The method of claim 15 wherein in the step of disposing the decorative pop-up attachment in the floral grouping, the decorative pop-up attachment is further defined as being disposed adjacent at least a portion of the stem portion of the floral grouping.

27. The method of claim 15 wherein in the step of connecting the decorative pop-up attachment to the floral grouping, the decorative pop-up attachment is further defined as being connected to the floral grouping via a frictional engagement between the decorative pop-up attachment and the floral grouping.

28. The method of claim 15 wherein in the step of providing a decorative pop-up attachment, at least a portion of the outer periphery of the sheet of material adjacent the decorative end follows an outline of the design indicia such that the decorative end is complementary in shape to the design indicia thereon.

29. A method for using a decorative pop-up attachment with a floral grouping, comprising the steps of:
providing a decorative pop-up attachment, comprising
a sheet of material having an outer periphery and a decorative end having design indicia thereon, at least a portion of the outer periphery adjacent the decorative end following the outline of the design indicia such that the decorative end is complementary in shape to the design indicia, the sheet of material sized smaller than at least a portion of an outer diameter of a floral grouping, said floral grouping having a flower portion and a stem portion;
disposing the decorative pop-up attachment in the floral grouping;
positioning the decorative pop-up attachment in the floral grouping whereby decorative end of the decorative pop-up attachment extends a distance away from the flower portion of the floral grouping for displaying design indicia on the decorative end; and
connecting the decorative pop-up attachment to the floral grouping.

30. The method of claim 29 wherein in the step of providing a decorative pop-up attachment, the decorative pop-up attachment further comprises a bonding material.

31. The method of claim 30 wherein the bonding material comprises an adhesive bonding material.

32. The method of claim 30 wherein the bonding material comprises a cohesive bonding material.

33. The method of claim 29 wherein in the step of providing a decorative pop-up attachment, the sheet of material is constructed from a material selected from the group consisting of paper, cellophane, foil, plastic film, metallized film, fabric, fiber, burlap, and any combination thereof.

34. The method of claim 29 wherein in the step of providing a decorative pop-up attachment, the sheet of material has characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

35. The method of claim 29 wherein in the step of providing a decorative pop-up attachment, the sheet of material has a thickness in a range of about 0.5 mils to about 50 mils.

36. The method of claim 29 wherein in the step of providing a decorative pop-up attachment, the sheet of material has a thickness in a range of about 1.0 mils to about 30 mils.

37. The method of claim 29 wherein in the step of providing a decorative pop-up attachment, the sheet of material has a thickness in a range of about 3.0 mils to about 25 mils.

38. The method of claim 29 wherein in the step of providing a decorative pop-up attachment, the sheet of material has a thickness in a range of about 4 mils to about 15 mils.

39. The method of claim 29 wherein in the step of providing a decorative pop-up attachment, the sheet of material has a thickness in a range of about 4 mils to about 10 mils.

40. The method of claim 29 wherein in the step of disposing the decorative pop-up attachment in the floral grouping, the decorative pop-up attachment is further defined as being disposed adjacent at least a portion of the stem portion of the floral grouping.

41. The method of claim 15 wherein in the step of connecting the decorative pop-up attachment to the floral grouping, the decorative pop-up attachment is further defined as being connected to the floral grouping via a frictional engagement between the decorative pop-up attachment and the floral grouping.

42. A method for using a decorative pop-up attachment, comprising the steps of:
providing a floral grouping having a flower portion and a stem portion, and having an outer diameter;
providing a decorative pop-up attachment, comprising
a sheet of material having an outer periphery and a decorative end having design indicia thereon, at least a portion of the outer periphery adjacent the decorative end following the outline of the design indicia such that the decorative end is complementary in shape to the design indicia, the sheet of material sized smaller than at least a portion of the outer diameter of the floral grouping;
disposing the decorative pop-up attachment in the floral grouping;
positioning the decorative pop-up attachment in the floral grouping whereby the decorative end of the decorative pop-up attachment extends a distance away from the flower portion of the floral grouping for displaying design indicia on the decorative end; and
connecting the decorative pop-up attachment to the floral grouping.

43. The method of claim 42 wherein in the step of providing a decorative pop-up. attachment, the decorative pop-up attachment further comprises a bonding material.

44. The method of claim 43 wherein the bonding material comprises an adhesive bonding material.

45. The method of claim 43 wherein the bonding material comprises a cohesive bonding material.

46. The method of claim 42 wherein in the step of providing a decorative pop-up attachment, the sheet of material is constructed from a material selected from the group consisting of paper, cellophane, foil, plastic film, metallized film, fabric, fiber, burlap, and any combination thereof.

47. The method of claim 42 wherein in the step of providing a decorative pop-up attachment, the sheet of material has characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

48. The method of claim 42 wherein in the step of providing a decorative pop-up attachment, the sheet of material has a thickness in a range of about 0.5 mils to about 50 mils.

49. The method of claim 42 wherein in the step of providing a decorative pop-up attachment, the sheet of material has a thickness in a range of about 1.0 mils to about 30 mils.

50. The method of claim 42 wherein in the step of providing a decorative pop-up attachment, the sheet of material has a thickness in a range of about 3.0 mils to about 25 mils.

51. The method of claim 42 wherein in the step of providing a decorative pop-up attachment, the sheet of material has a thickness in a range of about 4 mils to about 15 mils.

52. The method of claim 42 wherein in the step of providing a decorative pop-up attachment, the sheet of material has a thickness in a range of about 4 mils to about 10 mils.

53. The method of claim 42 wherein in the step of disposing the decorative pop-up attachment in the floral grouping, the decorative pop-up attachment is further defined as being disposed adjacent at least a portion of the stem portion of the floral grouping.

54. The method of claim 42 wherein in the step of connecting the decorative pop-up attachment to the floral grouping, the decorative pop-up attachment is further defined as being connected to the floral grouping via a frictional engagement between the decorative pop-up attachment and the floral grouping.
